(19) United States
(12) Patent Application Publication
(10) Pub. No.: US 2022/0366382 A1
(43) Pub. Date: Nov. 17, 2022

(54) SYSTEM AND METHOD OF SECURING CRYPTOCURRENCY BY A PRECIOUS OBJECT

(71) Applicant: Stanislav Kulyk, Lublin (PL)

(72) Inventor: Stanislav Kulyk, Lublin (PL)

(21) Appl. No.: 17/318,035

(22) Filed: May 12, 2021

(51) Int. Cl. G06Q 20/06; G06Q 20/36; G06T 15/08

(52) U.S. Cl. CPC G06Q 20/0655; G06Q 20/3678; G06T 15/08; G06Q 2220/00

(57) ABSTRACT

The present invention relates to a system and a method of securing cryptocurrency by a precious object, wherein the value of cryptocurrency is backed by the precious object. The system of present invention comprises a cryptocurrency issuer institution which owns the precious object, wherein the precious object is divided into a plurality of 3D fragments, each of which represented by one cryptocurrency coin, created by the cryptocurrency issuer institution. The main purpose of present invention is to allow any person including normal people with small savings, to invest in the precious object through the cryptocurrency. The system and method of the present invention address many substantial advantages over traditional way of investment.

### FIELD OF THE INVENTION

The present invention relates primarily to a capital preservation and more particularly it relates to a system and a method of securing cryptocurrency by a precious object, in which the value of cryptocurrency is backed by the precious object.

### BACKGROUND OF THE INVENTION

One of the most important things in wealth management is a capital preservation. Reliable and conservative method of the capital preservation is to purchase some kind of precious object. It can be a precious work of art, vintage armour, antique furniture, jewellery, books, coins etc.

The abovementioned things tend to increase its value as time goes on and not subject to devaluation as it can be with any asset related to financial markets.

Even during financial crises, precious objects continue to keep their value.

However, there are a few restraining factors associated with that type of investment can be mentioned.

Often, there is a multimillion U.S. dollar amount is needed to make a purchase of the precious object. This fact limits opportunity to preserve capital by this way to only limited group of people.

Money assets are frozen in the precious objects and cannot be used until owner will sell it. Selling of the precious object can take long time and sometimes require complex legal procedures.

It is mandatory to have a special secure vault which meets storage conditions for the precious object.

There are precious objects, which are stored only in museums and recognised as a cultural or a national heritage. Such objects usually cannot be sold. However, they could serve as good capital preservation assets.

Therefore, it is desirable to provide a system and a method to preserve the assets by securing the cryptocurrency with the precious objects.

### SUMMARY OF THE INVENTION

The present invention discloses a system and a method of securing cryptocurrency by a precious object, in which the value of cryptocurrency is backed by the precious object. The system of present invention comprises a cryptocurrency issuer institution which owns a precious object; the precious object is divided into a plurality of 3D fragments, each of which represented by one cryptocurrency coin; a cryptocurrency comprises a plurality of said cryptocurrency coins, created by the cryptocurrency issuer institution; and a plurality of cryptocurrency investors who purchase and hold the cryptocurrency coins secured by the precious object. The present invention allows investing in the precious object through the cryptocurrency, which addresses many substantial advantages over traditional way of investment.

According to the present invention, each cryptocurrency coin is pegged 1-to-1 with each 3D fragment. Any person is able to purchase a piece of the precious object by paying the cryptocurrency coin. The system and method of the present invention give an opportunity to invest in the precious objects even for normal people with small savings. A secure vault intended for storing the precious object is not needed as the cryptocurrency issuer company will take care of it. The cryptocurrency backed by the precious object can be used like any digital currency i.e. the holder can pay for something with a ‘piece of precious object’. The cryptocurrency can be automatically converted into other cryptocurrency or fiat money in just a few seconds.

Museum can store the precious object and in same time create the cryptocurrency secured by it. In this way, the museum retain the precious object and makes it possible to invest money in it for third parties.

The system and method of securing cryptocurrency by the precious object of present invention provides multifold benefits to the financial investors of any level which are described in the following pages of specification.

### BRIEF DESCRIPTION OF DRAWINGS

Other objects, advantages and novel features of the invention will become apparent from the following detailed description of the present embodiment when taken in conjunction with the accompanying drawings. These figures are not intended to limit the scope of the present invention but rather illustrate certain attributes thereof.

FIG. 1 is a block diagram showing a system of securing cryptocurrency by a precious object, according to an embodiment of the present invention. FIG. 2 is a flow chart showing a method of securing cryptocurrency by a precious object, according to an embodiment of the present invention. FIG. 3 is a schematic illustration of a transformation of a precious object into a plurality of cryptocurrency coins, according to an embodiment of the present invention.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE INVENTION

As required, detailed embodiments of the systems and methods are disclosed herein; however, it is to be understood that the disclosed embodiments are merely exemplary of the systems and methods, which can be embodied in various forms. Therefore, specific structural and functional details disclosed herein are not to be interpreted as limiting, but merely as a basis for the claims and as a representative basis for teaching one skilled in the art to variously employ the systems and methods in virtually any appropriately detailed structure. Further, the terms and phrases used herein are not intended to be limiting; but rather, to provide an understandable description of the systems and methods. While the specification concludes with claims defining the features of the systems and methods that are regarded as novel, it is believed that the systems and methods will be better understood from a consideration of the following description in conjunction with the drawing figures, in which like reference numerals are carried forward.

Before explaining the present invention in detail, it is to be understood that the invention is not limited in its application to the details of the construction and arrangement of parts illustrated in the accompanying drawings. The invention is capable of other embodiments, as depicted in different figures as described above and of being practiced or carried out in a variety of ways. It is to be understood that the phraseology and terminology employed herein is for the purpose of description and not of limitation.

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and

C).

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It is to be understood that the term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

It is to be understood that the term “a precious object” hereinafter refers to any kind of object which has high value because of its recognised uniqueness and/or considerable age.

It is to be understood that the term “a cryptocurrency” hereinafter refers to a special digital currency which maintain balances and payments of its users, with use of cryptography, only through decentralised peer-to-peer network, called blockchain.

It is to be understood that the term “a cryptocurrency issuer institution” hereinafter refers to any kind of legal entity which is able to purchase a precious object and create a cryptocurrency.

It is to be understood that the terms “a cryptocurrency investor” and “a client” are interchangeable and hereinafter refers to an entity or a private person who purchases and holds the cryptocurrency coins secured by a precious object.

It is to be understood that the terms “fragments” and “pieces” used hereinafter are interchangeable.

It is to be understood that the terms “secured by” and “backed by” used hereinafter are interchangeable.

It is to be understood that the term “a 3D scanner” hereinafter refers to a special electronic scanning device which is used for exact virtual 3D copy model of physical object reproduction. It can be a video camera working in pair with special software as well.

Reference will now be made in detail to a presently preferred embodiment of the invention, an example of which is illustrated in the accompanying drawings.

The present invention discloses a system and a method of securing a cryptocurrency by a precious object in which the precious object is divided into a plurality of fragments, each of which represented by one cryptocurrency coin.

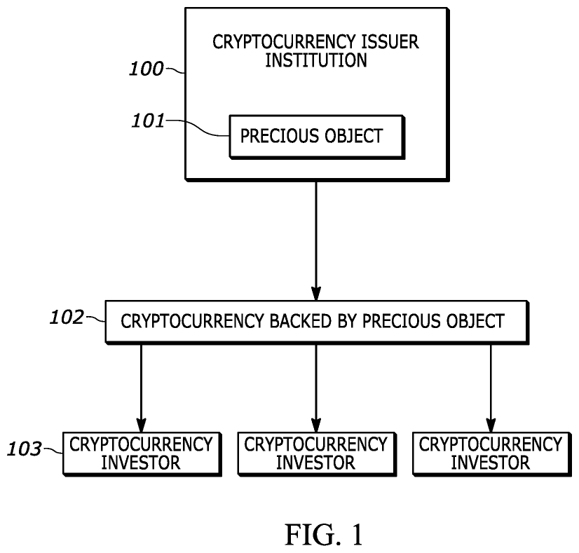

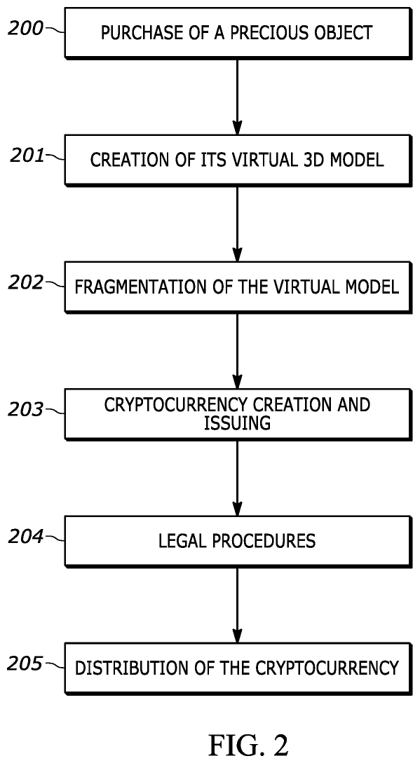

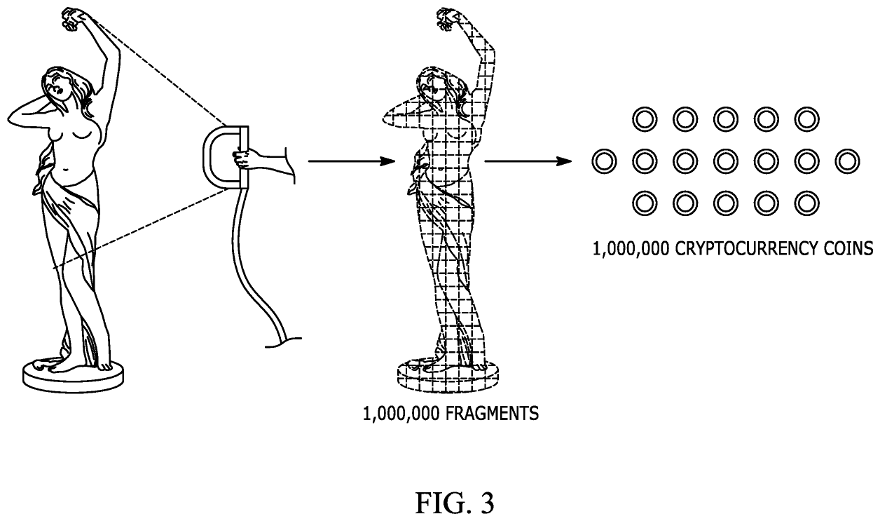

Referring to FIG. 1, according to an exemplary embodiment of the present invention, a system of securing cryptocurrency by a precious object is shown. The system of present invention comprises: a cryptocurrency issuer institution 100 which owns a precious object 101; the precious object 101, divided into a plurality of 3D fragments, each of which represented by one cryptocurrency coin; a cryptocurrency 102 comprises a plurality of said cryptocurrency coins, created by the cryptocurrency issuer institution 100; and a plurality of cryptocurrency investors 103 who purchase and hold the cryptocurrency coins secured by the precious object 101. The cryptocurrency issuer institution 100 can be a private company and/or a museum. The cryptocurrency coins are then fully and/or partially distributed among said plurality of cryptocurrency investors 103.

The objective of the present invention will become apparent from the following description of sequential steps represented by a flow diagram of the present invention. Referring now to FIG. 2, according to an embodiment of the present invention, a method of securing the cryptocurrency 102 by the precious object 101 using a software algorithm is disclosed in form of a plurality of key steps. The cryptocurrency 102 backed by the precious object 101 creation process comprises mainly six major steps. In FIG. 2, at an input step 200 starting with the process, the precious object 101 is purchased by the cryptocurrency issuer institution 100. The cryptocurrency issuer institution 100 obtains the precious object 101 from another institution, a private person, an archaeologist, a museum, an auction or any other trusted and/or legal place.

After purchasing the precious object 101, at next step 201, the cryptocurrency issuer institution 100 creates a virtual or digital 3D model of the precious object 101. For implementation of the step 201, a 3D scanner device is used. The 3D scanner can safely scan the shape and appearance of the precious object 101 and transfer an accurate data to a software which recreates its exact virtual 3D model.

At step 202, the virtual 3D model of the precious object 101 is fragmented into a plurality of 3D pieces of equal cubic volume. For the fragmentation of the virtual 3D model, the exact cubic volume value of the precious object 101 is calculated in a 3D editing software. Further, the cubic volume value is divided into needed amount of equal 3D pieces. One such 3D piece will secure value of one cryptocurrency coin i.e. when somebody buys a cryptocurrency coin, ultimately he/she buys a corresponding 3D piece of the precious object 101.

At step 203, the cryptocurrency 102 is created and issued with supply of cryptocurrency coins equal to 3D fragments count. Each cryptocurrency coin is pegged 1-to-1 with each 3D fragment. The cryptocurrency 102 backed by the precious object 101 can use its own blockchain or the blockchain of another cryptocurrency like Ethereum etc.

Further, at step 204, some legal procedures are being followed as per laws and regulations. It is likely that cryptocurrency legalisation is required before its distribution. Such legal procedures can vary depending on one or the other financial regulator and state where the cryptocurrency issuer institution 100 is based in.

At final step 205, the cryptocurrency coins are being distributed to said plurality of cryptocurrency investors 103. This step assumes conclusion of transactions for the sale of the cryptocurrency 102 with their clients 103. The initial price per cryptocurrency coin is based on a purchase cost of the precious object 101 and count of 3D pieces it was divided into. If the purchase of the precious object 101 was made significant time ago then expert assessment of its value will be needed. The initial price can also include expenses for storing it at a special secure vault, technical maintaining of cryptocurrency, taxes and so on.

After a successful sale transaction, the cryptocurrency issuer institution 100 will send an appropriate amount of the cryptocurrency coins to client's cryptocurrency wallet.

According to an embodiment of the present invention, a schematic view of the precious object 101, such as a statue is presented in FIG. 3, where the statue being scanned with the 3D scanner device is shown. The scanned statue is recreated into the virtual 3D model, where the recreated digital 3D model is divided into about 1,000,000 virtual 3D fragments with identical cubic volume as shown in FIG. 3. Further, the same amount i.e. 1,000,000 of the cryptocurrency coins secured by the aforesaid fragments are issued.

The above embodiments are described generally in terms of hardware and software. It will be recognized, however, that the functionality of the hardware can be further combined or even separated. The functionality of the software can also be further combined or even separated. Hardware can be replaced, at times, with software. Software can be replaced, at times, with hardware. Accordingly, the present embodiments should not be construed as limiting the scope of the claims here. One of ordinary skill in the art would recognize other variations, modifications, and alternatives. It is inferred that the foregoing description is only illustrative of the present invention and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

1. A method of securing cryptocurrency by a precious object, comprising the steps of:
creating a virtual 3D model of a precious object 101 by a 3D scanner device;
fragmenting the virtual 3D model of the precious object 101 into a plurality of 3D pieces of equal cubic volume; and
creating and issuing a cryptocurrency 102 with a plurality of cryptocurrency coins equal to the 3D fragments count.

2. The method of securing cryptocurrency by a precious object as claimed in claim 1, wherein in fragmenting step, the exact cubic volume value of the precious object 101 is calculated in a 3D editing software, and mathematically divided into needed number of 3D fragments.

3. A system of securing cryptocurrency by a precious object, comprising:
a cryptocurrency issuer institution 100 which owns a precious object 101;
the precious object 101, divided into a plurality of 3D fragments, each of which represented by one cryptocurrency coin;
a cryptocurrency 102 comprises a plurality of said cryptocurrency coins, created by the cryptocurrency issuer institution 100; and
a plurality of cryptocurrency investors 103 who purchase and hold the cryptocurrency coins secured by the precious object 101.

4. The system of securing cryptocurrency by a precious object as claimed in claim 3, wherein the cryptocurrency issuer institution 100 is a museum.
